(19) United States
(12) Patent Application Publication
(10) Pub. No.: US 2024/0210626 A1
(43) Pub. Date: Jun. 27, 2024

(54) IMAGE DISPLAY APPARATUS AND IMAGE DISPLAY METHOD

(71) Applicant: SONY GROUP CORPORATION, TOKYO (JP)

(72) Inventors: KAZUE SHIMIZU, TOKYO (JP); NOBUHIRO KIHARA, TOKYO (JP)

(21) Appl. No.: 18/291,333

(22) PCT Filed: Mar. 7, 2022
(86) PCT No.: PCT/JP2022/009706

§ 371 Date: Jan. 23, 2024

(30) Foreign Application Priority Data
Aug. 17, 2021 (JP) 2021-132709

(51) Int. Cl. G02B 6/26; G02B 6/34; G02B 27/01

(52) U.S. Cl. CPC G02B 6/262; G02B 6/34; G02B 27/0172; G02B 2027/0178

(57) ABSTRACT

To provide an image display apparatus capable of improving the use efficiency of incident light while downsizing an input-side optical element by simplifying the configuration. An image display apparatus (10) includes: an image forming unit (13) that emits image light; a light guide plate (11) that allows image light emitted from the image forming unit (13) to enter the light guide plate, travel inside the light guide plate, and be emitted outward from the light guide plate; a first optical element (14) that allows the image light entering the light guide plate (11) to be refracted and travel inside the light guide plate; and a second optical element (15) that allows the image light traveling inside the light guide plate (11) to be refracted and emitted outward from the light guide plate, in which at least one pair of reflective curved surfaces (16, 17) for reflecting the image light refracted by the first optical element (14) in a direction of the second optical element (15) is formed on side surfaces of the light guide plate.

### TECHNICAL FIELD

The present technology relates to an image display apparatus and an image display method. More specifically, the present technology relates to an image display apparatus and an image display method for displaying an image by using a light guide plate that allows incident light to travel inside the light guide plate and be emitted outward from the light guide plate.

### BACKGROUND ART

Conventionally, there is known an image display apparatus (eyewear) using an optical element such as a diffraction grating for changing a two-dimensional image formed by an image forming unit into a virtual image enlarged by a virtual-image optical system and providing it as an image to a user (observer).

For example, Patent Literature 1 has proposed an optical apparatus as a light guide plate-type AR glass system. The optical apparatus combines a light guide plate with an optical engine. The light guide plate has a pair of diffraction gratings with the same pitch as IN coupler and OUT coupler of a reflection-type volume hologram. The pair of diffraction gratings is provided on the light guide plate. The optical engine generates a video. With such a configuration, diffraction and emission through the OUT coupler in a light guide direction multiple times are repeated, thereby providing a pupil expansion effect. Therefore, according to Patent Literature 1, the IN coupler can be designed to have a small size in view of a thickness of the light guide plate and a light guide angle in order to prevent luminance unevenness in the light guide direction.

Moreover, Patent Literature 2 has proposed an image display apparatus as a system using a volume hologram. The image display apparatus has a plurality of slants arranged in a surface for tilting the angle of incidence outward. Moreover, since a light output surface also tilts outward, the image display apparatus refracts light beams to be emitted in an opposite direction by using side surfaces of a light guide member for reflecting the light beams. It is thus possible to increase the range of diffraction efficiency that can be provided with a single slant angle, reduce the number of manufacturing processes, and prevent an unnatural shape for eyeglasses in a case of viewing by both eyes. Moreover, according to Patent Literature 2, the directions of the light beams are merely changed, and no light beams are inverted with respect to a plane surface in the light guide direction.

Moreover, Patent Literature 3 has proposed a light guide apparatus as a system for downsizing an optical engine and reducing color unevenness. The light guide apparatus has a prism lens at a light input portion and performs pupil expansion with respect to a light incidence and guide direction through a multi-mirror. The technology according to Patent Literature 3 uses a technique of performing pupil expansion also in a vertical direction by providing diffraction gratings with the same pitch for allowing light to enter a second parallel plate and a second component with respect to the vertical direction via the diffraction gratings. Thus, according to Patent Literature 3, the optical engine can be downsized because pupil expansion is performed in both horizontal and vertical directions.

### CITATION LIST

### Patent Literature

Patent Literature 1: Japanese Patent Application Laid-open No. 2006-350129
Patent Literature 2: Japanese Patent Application Laid-open No. 2014-142386
Patent Literature 3: Japanese Patent Application Laid-open No. 2017-049290

### DISCLOSURE OF INVENTION

### Technical Problem

However, the technology according to Patent Literature 1 has no pupil expansion elements for an angle of view in a direction orthogonal to the light guide direction. Therefore, it is necessary to design a projection lens on the engine side for the observer's eyebox size. Therefore, there is a problem in that the size increases as compared to the light guide direction.

Moreover, the technology according to Patent Literature 2 is useful for adjusting the angle of incidence and the angle of emission by using the side surfaces. However, in terms of the IN size, there is a problem in that the size also increases as in the technology according to Patent Literature 1. For example, the size can be reduced in the light guide direction, but the size in the direction orthogonal to the light guide direction depends on a design for the projection lens. In addition, since refracting light on the side surfaces increases the light guide distance, the size increases. Therefore, there is a problem in that the projection lens further increases in size. Moreover, since the technology according to Patent Literature 2 uses a technique limited to a technique in which the angle of incidence is limited to the outside with respect to the light guide direction, it cannot be used in a case where it is designed for an angle of incidence of 0 degrees, for example. In addition, since incident light is reflected on the side surfaces, enters the diffraction grating again, and is guided through the diffraction grating, lowering in efficiency and unnecessary light emission due to the re-diffraction are inevitable. There is a problem in that it can cause ghosting in a case where it is configured to have a multi-plate structure for coloring or the like.

Moreover, as compared to the parallel plate technique that uses three diffraction gratings consisting of the diffraction grating at the light input portion, the diffraction grating for pupil expansion in the light guide direction, and the diffraction grating for emission and pupil expansion in the orthogonal direction, which enables the optical engine to be downsized, the technology according to Patent Literature 3 has a problem in that the angle of view in the orthogonal direction is restricted especially at a first pupil expansion component because of its non-continuous configuration. When the first pupil expansion component guides light beams, light beams in an angle-of-view direction orthogonal thereto spread. Since the optical path of return light reflected on the side surfaces of the first component is inverted, it causes mixing of incident angles of view, i.e., ghosting. In order to avoid it, it is necessary to increase the width of the first component and reduce the angle of view in the orthogonal direction. Therefore, there is a problem in that the angle of view is restricted. Moreover, even as compared to a system consisting of three diffraction gratings that can be fabricated by a single parallel plate, an increase in the number of components and an increase in the number of manufacturing processes are inevitable problems. In addition, when light travels in two axis directions, components of the light are inevitably lost in the light guide direction. Thus, the efficiency significantly lowers.

In view of this, it is a main object of the present technology to provide an image display apparatus capable of improving the use efficiency of incident light while downsizing an input-side optical element by simplifying the configuration.

### Solution to Problem

In the present technology, provided is an image display apparatus including:
an image forming unit that emits image light;
a light guide plate that allows image light emitted from the image forming unit to enter the light guide plate, travel inside the light guide plate, and be emitted outward from the light guide plate;
a first optical element that allows the image light entering the light guide plate to be refracted and travel inside the light guide plate; and
a second optical element that allows the image light traveling inside the light guide plate to be refracted and emitted outward from the light guide plate, in which
at least one pair of reflective curved surfaces is formed on side surfaces of the light guide plate, the at least one pair of reflective curved surfaces reflecting the image light refracted by the first optical element in a direction of the second optical element.

Moreover, in the present technology, provided is an image display method including:
a step of emitting image light;
a step of causing the emitted image light to enter a light guide plate;
a step of causing the image light entering the light guide plate to be refracted by a first optical element and travel inside the light guide plate;
a step of causing the image light entering the first optical element to be reflected in a direction of a second optical element, the image light being reflected on at least one pair of reflective curved surfaces formed on side surfaces of the light guide plate; and
a step of causing the image light traveling inside the light guide plate to be refracted by the second optical element and emitted outward from the light guide plate.

### Advantageous Effects of Invention

In accordance with the present technology, an image display apparatus capable of improving the use efficiency of incident light while downsizing an input-side optical element by simplifying the configuration is provided. It should be noted that the above-mentioned effects are not limitative and any one of the effects set forth in the present specification or other effects that can be conceived from the present specification may be provided in addition to or instead of the above-mentioned effects.

### BRIEF DESCRIPTION OF DRAWINGS

FIG. 1 A schematic configuration diagram showing an image display apparatus according to a first embodiment of the present technology.

FIG. 2 A schematic view showing pupil expansion using an output-side diffraction grating according to the first embodiment of the present technology.

FIG. 3 A schematic configuration diagram showing an image display apparatus according to a conventional technology.

FIG. 4 A conceptual diagram showing an arrangement example of a diffraction grating according to the first embodiment of the present technology.

FIG. 5 A conceptual diagram showing an arrangement example of the diffraction grating according to the first embodiment of the present technology.

FIG. 6 A schematic view showing a configuration example of a surface of the diffraction grating according to the first embodiment of the present technology.

FIG. 7 A schematic view showing a configuration example of a reflection-type volume hologram diffraction grating according to the first embodiment of the present technology.

FIG. 8 A schematic view showing a stack example of a light guide plate according to the first embodiment of the present technology.

FIG. 9 A conceptual diagram showing an arrangement example of a diffraction grating according to a second embodiment of the present technology.

FIG. 10 A schematic configuration diagram showing an image display apparatus according to a third embodiment of the present technology.

### MODE(S) FOR CARRYING OUT THE INVENTION

Hereinafter, favorable embodiments for carrying out the present technology will be described with reference to the drawings. The embodiments described below represent examples of typical embodiments of the present technology and any embodiments can be combined. Moreover, the scope of the present technology should not be understood narrowly due to them. It should be noted that descriptions will be given in the following order.
1. First Embodiment
(1) Configuration Example of Image Display Apparatus
(2) Configuration Example of Conventional Image Display Apparatus
(3) Concept of Afocal system
(4) Configuration Example of Diffraction Grating
(5) Stack Example of Light Guiding Plate
(6) Example of Image Display Method
2. Second Embodiment
3. Third Embodiment

### 1. First Embodiment

### (1) Configuration Example of Image Display Apparatus

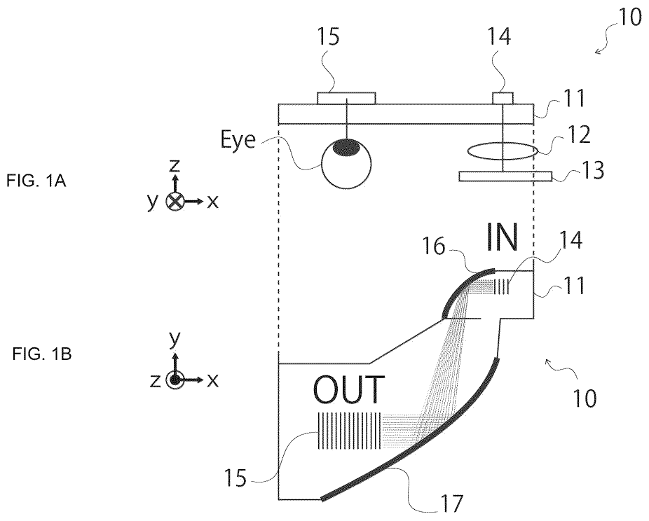

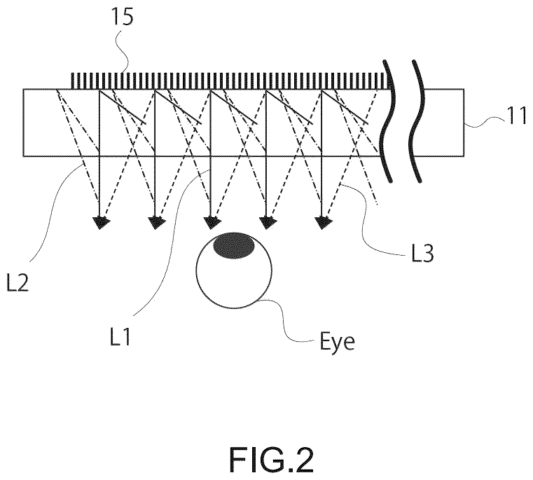

First of all, a configuration example of an image display apparatus 10 according to a first embodiment of the present technology will be described with reference to FIGS. 1 and 2.

A of FIG. 1 is a schematic configuration diagram of the image display apparatus 10 according to the present embodiment as viewed from above. B of FIG. 1 is a schematic configuration diagram of the image display apparatus 10 rotated by 90 degrees in a front direction on the sheet from the position in A of FIG. 1 as viewed from the front of the image display apparatus 10. In the present embodiment, it is assumed that a gaze direction of the user is a positive direction on the Z-axis, a right-hand direction on the X-axis on the sheet in FIG. 1 is a positive direction, and an upper direction on the sheet in B of FIG. 1 is a positive direction on the Y-axis. FIG. 2 is a schematic view showing pupil expansion using an output-side diffraction grating according to the present embodiment.

The image display apparatus 10 can be used as an eyeglass-type eyewear attached to vicinity of the user's eye, the eyewear including a diffraction grating-type light guide plate for diffracting light in a constant direction, for example. In particular, the image display apparatus 10 can be applied to an optical system for augmented reality (AR).

As shown in A of FIG. 1, the image display apparatus 10 includes, as an example, a light guide plate 11, a projection lens 12 that is an optical system, an image forming unit 13 having a light emission light source that emits image light or the like, an input-side diffraction grating 14 which is an incidence coupler as a first optical element, and an output-side diffraction grating 15 which is an emission coupler as a second optical element. The input-side diffraction grating 14 and the output-side diffraction grating 15 are both arranged on a surface on the front side of the light guide plate 11 which is opposite to a light incident surface. The input-side diffraction grating 14 and the output-side diffraction grating 15 have the same pitch and the same direction. The image display apparatus 10 uses, as an example, an LED light source (530 nm) as a light source and employs surface relief diffraction gratings as the input-side diffraction grating 14 and the output-side diffraction grating 15.

The light source of the image forming unit 13 has a display unit for generating a video or image. The light source of the image forming unit 13 may be a liquid crystal on silicon (LCOS)-type or a high temperature poly-silicon (HTPS)-type that performs self-light emission but has an illumination system such as a micro light emitting diode (micro-LED) or a micro organic light emitting diode (micro-OLED). The light source of the image forming unit 13 may be a digital light processing (DLP)-type or a laser beam scanning (LBS)-type. Moreover, an optical engine may be a combination of a transmissive liquid-crystal panel, a front-lid panel, or the like with a light source. It should be noted that the light source for self-light emission may be a light emitting diode (LED) light source integral with a panel with dispersion or may be a laser diode (LD) light source with a single wavelength or a vertical cavity surface emitting laser (VCSEL) light source.

Using a single wavelength like a laser light increases the color gamut provides higher image quality and makes it unnecessary to consider the chromatic dispersion. Therefore, the difficulty for forming an afocal system for the light guide plate 11 lowers. However, the laser light is more expensive than the LED light source, so it is useful to actively use the LED light source. In a case where a diffraction grating is used, there is an advantage that the angle of view extends because of the chromatic dispersion by the LED light source.

The image forming unit 13 is arranged so as to face one surface of the light guide plate 11 and emits image light toward the input-side diffraction grating 14 of the light guide plate 11. It should be noted that the image forming unit 13 may emit image light from a plurality of pixels having a plurality of wavelengths. Moreover, the image forming unit 13 may be configured to include an image generation unit that emits image light and an optical system that converts image light emitted from the image generation unit into collimated light for an angle of view. In addition, the image forming unit 13 may be configured to include a color filter.

The projection lens 12 is arranged between the image forming unit 13 and the light guide plate 11 and collects light emitted from the image forming unit 13. Moreover, the projection lens 12 is capable of converting image light with each image height emitted from the image forming unit 13 into collimated light for an angle of view. In the present embodiment, the projection lens 12 and the image forming unit 13 constitute the optical engine. It should be noted that the projection lens 12 may be arranged, tilted with respect to the light guide plate 11 or the image forming unit 13.

Plane surfaces of the light guide plate 11 have a parallel plate shape for guiding light beams from respective light sources without changing the respective light guide angles. Moreover, side surfaces of the light guide plate 11 is perpendicular to the plane surfaces. Image light emitted from the image forming unit 13 and collected through the projection lens 12 enters the light guide plate 11, and the entering image light travels inside the light guide plate 11 and is emitted outward from the light guide plate 11. A detailed configuration of the light guide plate 11 will be described later.

The input-side diffraction grating 14 is, as an example, a transmission-type diffraction grating. The input-side diffraction grating 14 is arranged at one end of a surface opposite to an incident surface side of the light guide plate 11 on which the image forming unit 13 is arranged. The input-side diffraction grating 14 is a diffraction grating for refracting image light from the outside of the light guide plate 11 in a direction of the light guide angle. The input-side diffraction grating 14 refracts, diffracts, and reflects the image light entering the light guide plate 11 and allows the image light to travel inside the light guide plate 11.

The output-side diffraction grating 15 is, as an example, a transmission-type diffraction grating. The output-side diffraction grating 15 is arranged at the other end of the same surface as the surface of the light guide plate 11 on which the input-side diffraction grating 14 is arranged. The output-side diffraction grating 15 is a diffraction grating for emitting guided image light outward from the light guide plate 11. The output-side diffraction grating 15 transmits and diffracts the image light traveling inside the light guide plate 11 and emits the image light outward from the light guide plate 11. The output-side diffraction grating 15 has the same diffraction grating pitch as the input-side diffraction grating 14. The output-side diffraction grating 15 has a function of closing the grating vector. Moreover, the output-side diffraction grating 15 may have a function of pupil expansion. It should be noted that the input-side diffraction grating 14 and the output-side diffraction grating 15 may be reflection-type diffraction gratings or may be volumetric or surface relief diffraction gratings. It should be noted that the surface relief diffraction gratings can be fabricated by a technique such as imprinting, injection molding, etching, or casting.

As shown in B of FIG. 1, a first reflective curved surface 16 on the input-side on which image light refracted by the input-side diffraction grating 14 is reflected and a second reflective curved surface 17 on the output-side on which image light reflected by the first reflective curved surface 16 is reflected in a direction of the output-side diffraction grating 15 are formed on the side surfaces of the light guide plate 11. The first reflective curved surface 16 and the second reflective curved surface 17 form a pair of reflective curved surfaces on the light guide plate 11.

The first reflective curved surface 16 and the second reflective curved surface 17 are, as an example, formed with different curvature radii. The first reflective curved surface 16 and the second reflective curved surface 17 have non-spherical surface shapes closer to parabolic surfaces, which are afocal system curved surface shapes with a magnification of 1× or more. In the present embodiment, the magnification of the curvature radius of the second reflective curved surface 17 on the output-side with respect to the first reflective curved surface 16 on the image light input-side is a value larger than 1. Moreover, regarding the first reflective curved surface 16 and the second reflective curved surface 17, their cross-sections in an orthogonal axis direction have linear shapes. Effective light beams entering the first reflective curved surface 16 and the second reflective curved surface 17 satisfy a total internal reflection condition.

The side surfaces of the light guide plate 11 have some curvatures in the first reflective curved surface 16 and the second reflective curved surface 17 as viewed in the plane surface (XY-plane shown in B of FIG. 1) of the light guide plate 11. Meanwhile, on a cross-section (XZ-plane shown in A of FIG. 1) orthogonal to the plane surface, they are perpendicular to the plane surface of the light guide plate 11. That is, the light guide plate 11 is formed as a cylindrical mirror whose cross-section shape is a curve with a high-order derivative, such as a parabola, circle, or ellipse. In a case where the cross-section of the light guide plate 11 is not perpendicular, light radiated to the cross-section changes in light beam angle and has a different angle when the light is emitted outward from the light guide plate 11. It leads to image quality degradation. With such a configuration, the light guide plate 11 can suppress this image quality degradation.

The user observes an image displayed by image light, which has been diffracted and reflected through the output-side diffraction grating 15 from the side on which the image forming unit 13 is arranged and emitted outward from the light guide plate 11, by an eye Eye positioned on the same side as the image forming unit 13 with respect to the light guide plate 11 for example.

As shown in A of FIG. 1, a plurality of image light rays emitted from the image forming unit 13 such as a panel is, as an example, converted (collimated) into collimated light rays with different angles of view through the projection lens 12 and further converted into light with an angle in the light guide direction through the input-side diffraction grating 14 on the surface of the light guide plate 11. The light guide plate 11 has, as an example, a thickness of about 1 mm or less. Image light is taken and guided into the thin parallel plate.

On the cross-section in the XZ-plane of the light guide plate 11, the guided light strikes the output-side diffraction grating 15 having the same pitch as the input-side diffraction grating 14 and is emitted from the light guide plate 11 in a direction of the eye Eye of the user. At this time, the guided incident light rays with different angles are reflected on the first reflective curved surface 16 and the second reflective curved surface 17. The output-side diffraction grating 15 makes the guided incident light rays with the different angles to have the angles before the incident light rays enter the light guide plate 11. The user can view an image when those light rays enter the pupils of the eyes Eye.

As shown in FIG. 2, the image display apparatus 10 provides a pupil expansion effect in such a manner that incident light L1, L2, and L3 with different angles strike the output-side diffraction grating 15 multiple times while being guided through the output-side diffraction grating 15. Even if the size of the input-side diffraction grating 14 in this light guide direction is relatively small, an angle-of-view enlargement effect is provided in accordance with the pupil expansion principle when incident image light for an angle of view enters the pupil of the eye Eye. It influences the angle of view in the light guide direction of the incident light. However, the angle of view in the direction orthogonal to the light guide direction depends on the optical path on the XY-plane.

### (2) Configuration Example of Conventional Image Display Apparatus

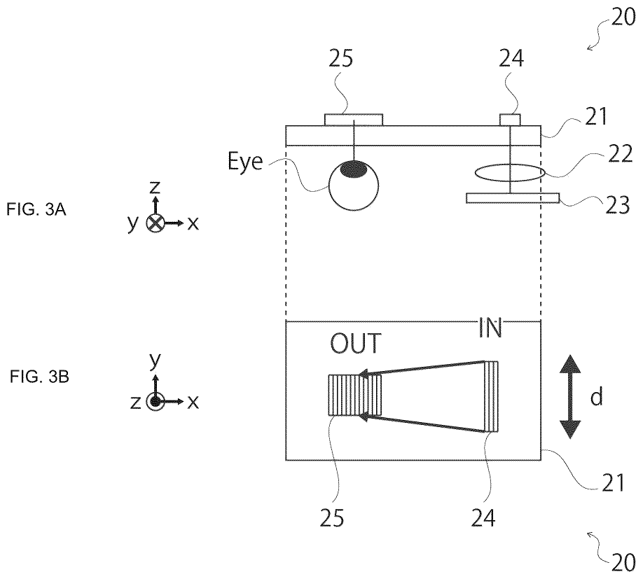

Here, a configuration example of an image display apparatus 20 according to a conventional technology will be described with reference to FIG. 3. FIG. 3 is a schematic configuration diagram showing the image display apparatus 20 according to the conventional technology.

A of FIG. 3 is a schematic configuration diagram of the image display apparatus 20 according to the conventional technology as viewed from above. B of FIG. 3 is a schematic configuration diagram of the image display apparatus 20 rotated by 90 degrees in a front direction on the sheet from the position in A of FIG. 3 as viewed from the front of the image display apparatus 20. In FIG. 3, it is assumed that a gaze direction of the user is a positive direction on the Z-axis, a right-hand direction on the X-axis on the sheet in FIG. 3 is a positive direction, and an upper direction on the sheet in B of FIG. 3 is a positive direction on the Y-axis.

As shown in A of FIG. 3, the image display apparatus 20 according to the conventional technology includes, as an example, a light guide plate 21, a projection lens 22 that is an optical system, an image forming unit 23 having a light emission light source that emits image light or the like, an input-side diffraction grating 24 that is an incidence coupler, and an output-side diffraction grating 25 that is an emission coupler. The input-side diffraction grating 24 and the output-side diffraction grating 25 are provided on a surface on the front side of the light guide plate 21 which is opposite to a light incident surface so as to have the same pitch.

As shown in B of FIG. 3, in the XY-plane of the light guide plate 11, the width of the input-side diffraction grating 24 in an image light travelling direction is made to be larger than the width of the output-side diffraction grating 15. It is for causing light beams to enter the pupil of the eye Eye of the user so that a designed angle of view can be obtained. Therefore, in the image display apparatus 20, the size of the input-side diffraction grating 24 and the size of the optical engine in an angle-of-view direction increase.

Moreover, it is typically designed so that no incident light strikes the side surfaces of the light guide plate 21. It is because without such a design, incident light is reflected and inverted, such that the light beam angle becomes the same as another angle of view, which causes ghosting.

In this manner, the size of the input-side diffraction grating 24 and the size of the projection lens 22 increase in the light guide direction in the light guide plate 21 for 1-axis pupil expansion provided in the image display apparatus 20 according to the conventional technology, which has been a problem. In this regard, a technique of downsizing the input-side diffraction grating by performing pupil expansion in two axis directions has been proposed. However, this technique has a problem in that the number of components increases and a problem in that in a case where two pupil expansion systems are separated, the angle of view in the first pupil expansion system orthogonal to the first light guide axis is restricted by its width and cannot be sufficiently increased. Moreover, also in a case where the two pupil expansion systems are not separated, there is a problem in that light is lost in the travelling directions on the two axes, and it is known that the efficiency significantly lowers.

In view of this, in the image display apparatus 10 according to the present embodiment, a pair of afocal system curved surfaces actively using the side surfaces of the light guide plate 11 is used for changing the optical paths of light beams so that it seems that light beams from the small input-side diffraction grating 14 are light beams from a large input-side diffraction grating.

### (3) Concept of Afocal System

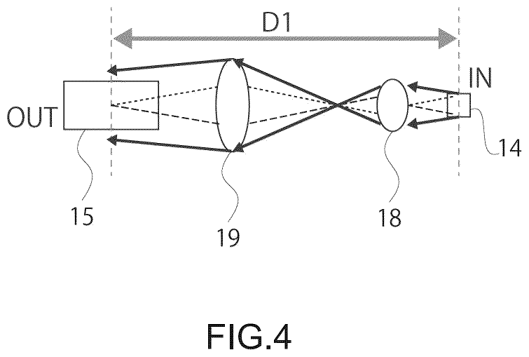

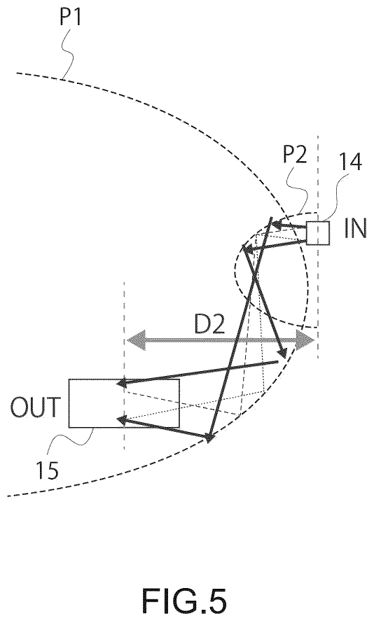

A concept of an afocal system applied to the image display apparatus 10 according to the present embodiment will be described with reference to FIGS. 4 and 5. FIG. 4 is a conceptual diagram showing an arrangement example where the light guide plate 11 is a diffraction grating based on a transmission-type afocal system. FIG. 5 is a conceptual diagram showing an arrangement example where the light guide plate 11 is a diffraction grating based on a reflection-type afocal system. Here, the afocal system refers to an optical system in which a collimated light flux becomes a collimated light flux again after the collimated light flux passes through lens, optical element, and the like.

As shown in FIG. 4, in a case of the transmission-type afocal system, the input-side diffraction grating 14 and the output-side diffraction grating 15 are arranged in linear shapes and two projection lenses 18 and 19 with different sizes are arranged between the input-side diffraction grating 14 and the output-side diffraction grating 15.

Typically, it is conceivable that the light guide plate of the image display apparatus constitutes the transmission-type afocal system as described above. However, in this case, since each optical surface uses a refractive index difference due to different refractive indices, it is necessary to use different refraction materials or fabricate it with diffraction grating surfaces with different lens functions in order to employ this. Therefore, the number of components and the number of manufacturing processes increase and the manufacturing difficulty increases. Moreover, as shown in FIG. 4, a linear distance D1 between the input-side diffraction grating 14 and the output-side diffraction grating 15 increases in the light guide direction, and it is difficult to actually manufacture it because of a relationship with the light guide distance that can make it eyeglasses.

In this regard, as shown in FIG. 5, in a case of the reflection-type afocal system, the input-side diffraction grating 14 and the output-side diffraction grating 15 are arranged so as to face each other via focal points on two parabolic surfaces P1 and P2, shifted from each other in a direction perpendicular to the light guide direction, thereby realizing the afocal system. Accordingly, with the light guide plate 11, a distance D2 between the input-side diffraction grating 14 and the output-side diffraction grating 15 in the light guide direction as the eyeglasses can be reduced using bouncing back of light by shifting the optical axis. Therefore, the image display apparatus 10 can reduce the number of components by using the side surfaces of the light guide plate 11 and can also achieve downsizing. It should be noted that the image display apparatus 10 can also form a structure as the afocal system by using the first reflective curved surface 16 and the second reflective curved surface 17 which are the one pair of reflective curved surfaces and the projection lens 12 of the optical engine.

In the present embodiment, as an example, the first reflective curved surface 16 and the second reflective curved surface 17 have non-spherical surface shapes similar to the parabolic surfaces and the magnification of the afocal system is designed to be about 3×. In this manner, employing the shape similar to the parabolic surface allows the total internal reflection condition to be satisfied regarding the angle of incidence of light upon the first reflective curved surface 16 and the second reflective curved surface 17 as viewed on the XY-plane of the light guide plate 11. Therefore, the light guide plate 11 can principally realize high reflection of about 100%. It should be noted that although the input-side diffraction grating 14 can be made smaller in size as the magnification of the angle of incidence is increased, the design difficulty also increases because it becomes more asymmetric.

Moreover, the first reflective curved surface 16 and the second reflective curved surface 17 which are the pair of curved surfaces are formed with different curvature radii, and they have linear shapes on the cross-section (XZ-plane) in the Z-axis direction and are parallel to the Z-axis. That is, the first reflective curved surface 16 and the second reflective curved surface 17 do not have any curvature on the cross-section in the Z-axis direction. In addition, at least the pair of curved surfaces needs to be parallel to each other. It is for maintaining the light beam angle especially on the XZ-plane also after the incident light passes through the afocal system.

The light guide plate 11 is formed as the afocal system on the XY-plane and as the pupil expansion structure similar to the conventional one on the XZ-plane. In the present embodiment, the angular magnification M of the afocal system of the first reflective curved surface 16 with respect to the second reflective curved surface 17 is set to be 3×. However, it is sufficient that the angular magnification M is larger than 1×. Here, the angular magnification M refers to a magnification of an input-side curved surface IN with respect to an emission-side curved surface OUT (M=IN/OUT). It is because this can make the size of the output-side diffraction grating 15 larger than the size of the input-side diffraction grating 14. It should be noted that the angular magnification M of the afocal system can be arbitrarily designed in consideration of designed performance and a distance between the optical engine and the pupil.

The afocal system for the light guide plate 11 employs the non-spherical surface shape similar to the parabolic surface as the curved surface on the XY-plane. However, the shape of the reflective curved surface may be a shape selected from a group consisting of a parabolic surface shape, an elliptical surface shape, a spherical surface shape, a non-spherical surface shape, and a combination thereof. It should be noted that in any shape, the YZ-plane and the XZ-plane of the light guide plate 11 are perpendicular surfaces.

In the present embodiment, since angles of incidence of light upon the first reflective curved surface 16 and the second reflective curved surface 17 are configured to satisfy the total internal reflection condition, it is unnecessary to apply a coating on these curved surfaces. Moreover, the present technology can also be applied even if they do not satisfy the total internal reflection condition. However, in this case, since light is reflected on the first reflective curved surface 16 and the second reflective curved surface 17, it is necessary to apply a reflective coating on these curved surfaces. In a case of applying a reflective coating, it can be made of a metal film coating and/or a multi-layer film mirror coating such as aluminum or silver.

### (4) Configuration Example of Diffraction Grating

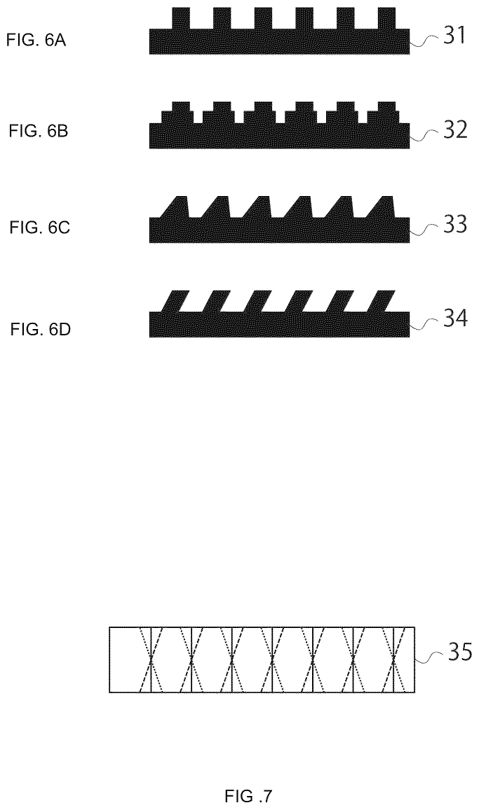

Next, configuration examples of diffraction gratings used for the image display apparatus 10 according to the present embodiment will be described with reference to FIGS. 6 and 7. FIG. 6 is schematic views showing configuration examples of the surface of the surface relief diffraction grating according to the present embodiment. FIG. 7 is a schematic view showing a configuration example of the reflection-type volume hologram diffraction grating according to the present embodiment. The diffraction grating used for the image display apparatus 10 may be a surface relief diffraction grating or may be a volume hologram-type diffraction grating.

As shown in A of FIG. 6 to D of FIG. 6, a binary diffraction grating 31, an echelle diffraction grating 32, a blazed diffraction grating 33, a slanted diffraction grating 34, and the like can be applied as the surfaces of the input-side diffraction grating 14 and the output-side diffraction grating 15 in the image display apparatus 10. Otherwise, a trapezoidal diffraction grating, a meta-surface diffraction grating, a diffraction grating using a holographic optical element (HOE), or the like may be applied.

In a case of using the echelle-type, blazed-type, the trapezoid-type, the slanted-type, the metasurface-type, or the HOE, employing an asymmetric shape can provide the diffraction efficiency with respect to the incident direction with an asymmetric property, and the diffraction efficiency can be increased in a necessary direction in consideration of ray paths. Moreover, in a case of the binary-type, the echelle-type, the blazed-type, the trapezoid-type, or the metasurface-type, not providing the asymmetric property but providing symmetric diffraction efficiency in both directions at the incident angle can serve to expand light beams in the both directions in the output-side diffraction grating 15. In this manner, it is desirable to arbitrarily configure one suitable for diffraction efficiency and a distribution of the diffraction efficiency, and it is also possible to apply a high-refraction or metal film coating on the surface.

As shown in FIG. 7, in a case where each of the input-side diffraction grating 14 and the output-side diffraction grating 15 in the image display apparatus 10 is a reflection-type volume hologram diffraction grating 35, it can cause a plurality of slants to be exposed to light and realize diffraction efficiency in a wide range because regarding the angular distribution of the diffraction efficiency, selectivity for the wavelength distribution is high. Moreover, a configuration in which a plurality of slants is stacked may be made or a configuration in which only one slant realizes the diffraction efficiency in a wide range may be made.

The diffraction grating 35 can be fabricated by exposing a plurality of slants with a constant pitch to interference light. Accordingly, the diffraction grating 35 can extend the angular distribution of the diffraction efficiency.

Diffraction gratings that can be applied to the input-side diffraction grating 14 and the output-side diffraction grating 15 may be reflective and/or transmissive. That is, both of the input-side diffraction grating 14 and the output-side diffraction grating 15 may be reflection-type diffraction gratings or transmission-type diffraction gratings or the input-side diffraction grating 14 and the output-side diffraction grating 15 may be either a reflection-type diffraction grating or a transmission-type diffraction grating. The input-side diffraction grating 14 and the output-side diffraction grating 15 may be configured in any shape in accordance with a diffraction efficiency distribution, efficiency and ghosting in a case of stacking a plurality of light guide plates 11, or the like.

### (5) Stack Example of Light Guide Plate

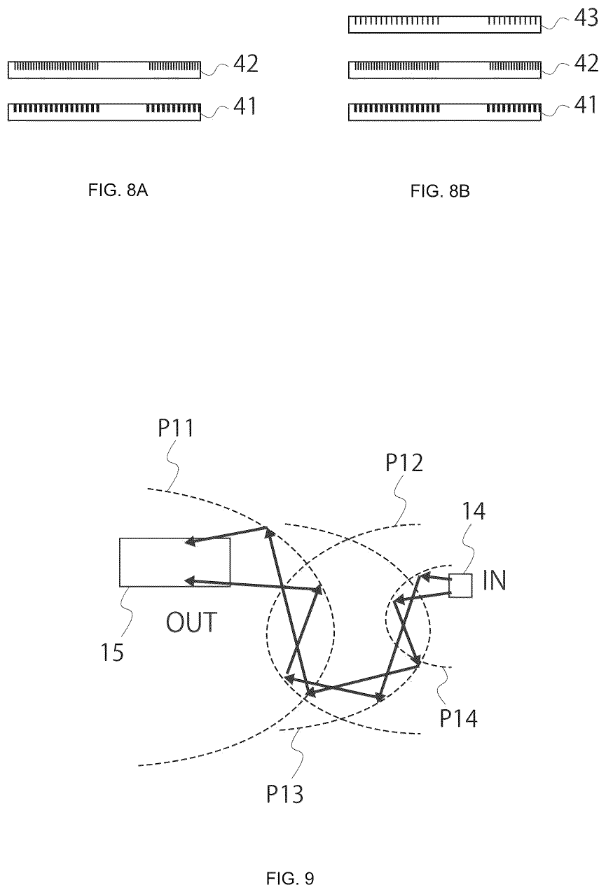

Next, a stack example of light guide plates of the image display apparatus 10 according to the present embodiment will be described with reference to FIG. 8. A of FIG. 8 is a schematic view showing a stack example of two light guide plates. B of FIG. 8 is a schematic view showing a stack example of three light guide plates.

As shown in A of FIG. 8, in the image display apparatus 10, two light guide plates 41 and 42 can be stacked. In this case, the light guide plates 41 and the light guide plate 42 can be constituted by two light guide plates of blue and green (BG), two light guide plates of green and red (GR), or two light guide plates of the same color.

As shown in B of FIG. 8, in the image display apparatus 10, three light guide plates 41 to 43 can be stacked. In this case, the light guide plates 41 to 43 can be respectively configured with three RGB colors. It should be noted that the stack pattern for the light guide plates of the image display apparatus 10 is not limited thereto, and four or more light guide plates may be stacked.

In this manner, the image display apparatus 10 can configured by stacking a plurality of light guide plates for coloring or extension of the angle of view for sharing the angle of view. In this case, an air layer or a sufficiently low-refraction material needs to be provided in the gap between the light guide plates in order to accomplish the total internal reflection condition.

### (6) Example of Image Display Method

Next, an example of the image display method using the image display apparatus 10 according to the present embodiment will be described with reference to FIGS. 1, 2, and 5.

The image display method using the image display apparatus 10 includes: a step of emitting image light from the image forming unit 13; a step of causing the emitted image light to enter the light guide plate 11; a step of causing the image light entering the light guide plate 11 to be refracted by the input-side diffraction grating 14 and travel inside the light guide plate 11; a step of causing the image light entering from the first reflective curved surface 16 formed on the side surfaces of the light guide plate 11 to be reflected in a direction of the second reflective curved surface 17 formed on the side surfaces of the light guide plate 11; and a step of emitting the image light travelling inside the light guide plate 11 to be refracted by the second reflective curved surface 17 outward from the light guide plate 11.

The image display apparatus 10 according to the present embodiment is formed with a structure using reflection at the edge on the side surfaces of the light guide plate 11 having a diffraction grating having a 1-axis configuration. In the image display apparatus 10 and the image display method using the same, it is a technology of converting a light beam from the small input-side diffraction grating 14 into an arrangement as if it were a light beam from the large diffraction grating by actively using reflection on the side surfaces by configuring the afocal system.

At that time, the afocal system is configured by two side surfaces in the wide plane surface of the light guide plate 11 and it is linear on the thin side surfaces and does not have a magnification in the thickness direction. The upper surface and the lower surface of the light guide plate 11 are parallel to each other. In particular, when an effective angle of incidence of a light beam upon the first reflective curved surface 16 and the second reflective curved surface 17 on the wide plane surface satisfies the total internal reflection condition, the reflectance is principally about 100% and conversion can be achieved at high efficiency.

Therefore, in accordance with the image display apparatus 10 and the image display method using the same, the use efficiency of incident light can be improved while the input-side diffraction grating 14 and the optical engine can be downsized by simplifying the configuration.

### 2. Second Embodiment

Next, a concept of an afocal system applied to an image display apparatus according to a second embodiment will be described with reference to FIG. 9. FIG. 9 is a conceptual diagram showing an arrangement example of a diffraction grating based on a reflection-type afocal system according to the present embodiment.

As shown in FIG. 9, two or more pairs of reflective curved surfaces are formed on side surfaces of a light guide plate provided in the image display apparatus according to the present embodiment. In the light guide plate according to the present embodiment, the afocal system is realized by arranging the input-side diffraction grating 14 and the output-side diffraction grating 15 so as to face each other via focal points on four parabolic surfaces P11 to P14.

Accordingly, also with the light guide plate according to the present embodiment, the distance between the input-side diffraction grating 14 and the output-side diffraction grating 15 in the light guide direction as the eyeglasses can be reduced using bouncing back of light four times by shifting the optical axis as in the light guide plate 11 according to the first embodiment. Therefore, the image display apparatus according to the present embodiment can also reduce the number of components by using the side surfaces of the light guide plate and achieve downsizing.

### 3. Third Embodiment

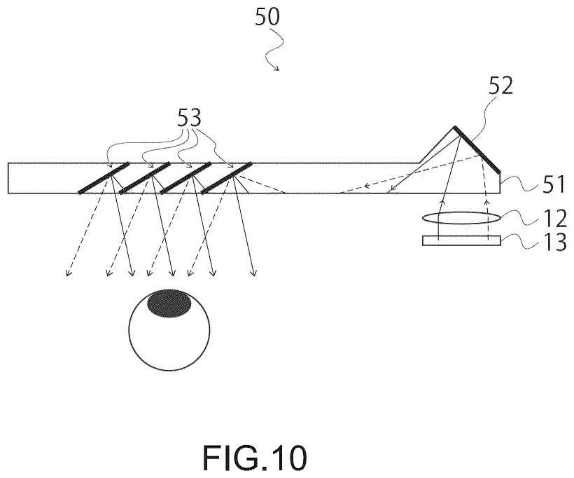

Next, a configuration example of an image display apparatus 50 according to a third embodiment of the present technology will be described with reference to FIG. 10. FIG. 10 is a schematic configuration diagram of the image display apparatus 50 according to the present embodiment as viewed from above. The image display apparatus 50 according to the present embodiment is different from the image display apparatus 10 according to the first embodiment in that the input-side diffraction grating and the output-side diffraction grating are replaced by a prism mirror and multi-half mirrors.

As shown in FIG. 10, the image display apparatus 50 includes, as an example, a light guide plate 51, a projection lens 12 that is an optical system, an image forming unit 13 having a light emission light source that emits image light or the like, a prism mirror 52 on the input-side as a first optical element, and multi-half mirrors 53 on the output-side as a second optical element.

It should be noted that a single prism mirror 52 and a single multi-half mirror 53 may be provided or a plurality of prism mirrors 52 and a plurality of multi-half mirrors 53 may be provided. Moreover, the image display apparatus 50 may be configured to include the multi-half mirrors 53 on the input-side of the light guide plate 51 and include the prism mirror 52 on the output-side.

The image display apparatus 50 according to the present embodiment can improve the use efficiency of incident light while downsizing the input-side diffraction grating 14 and the optical engine by simplifying the configuration as in the image display apparatus 10 according to the first embodiment.

It should be noted that the present technology can take the following configurations.
(1) An image display apparatus, including:
   an image forming unit that emits image light;
   a light guide plate that allows image light emitted from the image forming unit to enter the light guide plate, travel inside the light guide plate, and be emitted outward from the light guide plate;
   a first optical element that allows the image light entering the light guide plate to be refracted and travel inside the light guide plate; and
   a second optical element that allows the image light traveling inside the light guide plate to be refracted and emitted outward from the light guide plate, in which
   at least one pair of reflective curved surfaces is formed on side surfaces of the light guide plate, the at least one pair of reflective curved surfaces reflecting the image light refracted by the first optical element in a direction of the second optical element.
(2) The image display apparatus according to (1), in which
   the one pair of reflective curved surfaces is formed with different curvature radii.
(3) The image display apparatus according to (2), in which
   a magnification of the curvature radius of the reflective curved surface on an output side for the image light with respect to the reflective curved surface on an input side for the image light is a value larger than 1.
(4) The image display apparatus according to any one of (1) to (3), in which
   the light guide plate has a plate shape whose plane surfaces are parallel and the side surfaces of the light guide plate are perpendicular to the plane surfaces.
(5) The image display apparatus according to any one of (1) to (4), in which
   a shape of the reflective curved surface is a shape selected from a group consisting of a parabolic surface shape, an elliptical surface shape, a spherical surface shape, a non-spherical surface shape, and a combination thereof.
(6) The image display apparatus according to any one of (1) to (5), in which
   an effective light beam that enters the reflective curved surface satisfies a total internal reflection condition.
(7) The image display apparatus according to any one of (1) to (6), in which
   a reflective coating is applied to the reflective curved surface.
(8) The image display apparatus according to (7), in which
   the reflective coating is a metal film coating and/or a multi-layer film coating.
(9) The image display apparatus according to any one of (1) to (8), in which
   the first optical element and the second optical element have same pitch and same direction.
(10) The image display apparatus according to any one of (1) to (10), in which
   the first optical element and the second optical element are surface relief diffraction gratings.
(11) The image display apparatus according to any one of (1) to (10), in which
   the first optical element and the second optical element are holographic optical elements.
(12) The image display apparatus according to any one of (1) to (11), in which
   both the first optical element and the second optical element are reflection-type diffraction gratings or transmission-type diffraction gratings.
(13) The image display apparatus according to any one of (1) to (12), in which
   the first optical element and the second optical element are either a reflection-type diffraction grating or a transmission-type diffraction grating.
(14) The image display apparatus according to any one of (1) to (13), in which
   the first optical element and the second optical element are either a prism or a multi-mirror.
(15) The image display apparatus according to any one of (1) to (14), in which
   two or more pairs of the reflective curved surfaces are formed on the side surfaces of the light guide plate.
(16) The image display apparatus according to any one of (1) to (15), in which
   the image forming unit has an image generation unit that emits the image light and an optical system that converts the image light emitted from the image generation unit into collimated light for an angle of view.
(17) The image display apparatus according to any one of (1) to (16), in which
   the image forming unit has a color filter.
(18) The image display apparatus according to any one of (1) to (17), in which
   the light guide plate includes a plurality of stacked light guide plates.
(19) The image display apparatus according to any one of (1) to (18), in which
   the image display apparatus is an eyewear attached to vicinity of a user's eye.
(20) An image display method, including:
   a step of emitting image light;
   a step of causing the emitted image light to enter a light guide plate;
   a step of causing the image light entering the light guide plate to be refracted by a first optical element and travel inside the light guide plate;
   a step of causing the image light entering the first optical element to be reflected in a direction of a second optical element, the image light being reflected on at least one pair of reflective curved surfaces formed on side surfaces of the light guide plate; and
   a step of causing the image light traveling inside the light guide plate to be refracted by the second optical element and emitted outward from the light guide plate.

### REFERENCE SIGNS LIST

10, 20, 50 image display apparatus
11, 21, 41 to 43, 51 light guide plate
12, 18, 19, 22 projection lens (optical system)
13, 23 image forming unit
14, 24 input-side diffraction grating (first optical element)
15, 25 output-side diffraction grating (second optical element)
16 first reflective curved surface
17 second reflective curved surface
31 to 35 diffraction grating
52 prism mirror
53 multi-half mirror
Eye eye
L1, L2, L3 image light
D1, D2 diffraction grating-to-diffraction grating distance
P1, P2, P11 to P14 afocal curve

1. An image display apparatus, comprising:
an image forming unit that emits image light;
a light guide plate that allows image light emitted from the image forming unit to enter the light guide plate, travel inside the light guide plate, and be emitted outward from the light guide plate;
a first optical element that allows the image light entering the light guide plate to be refracted and travel inside the light guide plate; and
a second optical element that allows the image light traveling inside the light guide plate to be refracted and emitted outward from the light guide plate, wherein
at least one pair of reflective curved surfaces is formed on side surfaces of the light guide plate, the at least one pair of reflective curved surfaces reflecting the image light refracted by the first optical element in a direction of the second optical element.

2. The image display apparatus according to claim 1, wherein
the one pair of reflective curved surfaces is formed with different curvature radii.

3. The image display apparatus according to claim 2, wherein
a magnification of the curvature radius of the reflective curved surface on an output side for the image light with respect to the reflective curved surface on an input side for the image light is a value larger than 1.

4. The image display apparatus according to claim 1, wherein
the light guide plate has a plate shape whose plane surfaces are parallel and the side surfaces of the light guide plate are perpendicular to the plane surfaces.

5. The image display apparatus according to claim 1, wherein
a shape of the reflective curved surface is a shape selected from a group consisting of a parabolic surface shape, an elliptical surface shape, a spherical surface shape, a non-spherical surface shape, and a combination thereof.

6. The image display apparatus according to claim 1, wherein
an effective light beam that enters the reflective curved surface satisfies a total internal reflection condition.

7. The image display apparatus according to claim 1, wherein
a reflective coating is applied to the reflective curved surface.

8. The image display apparatus according to claim 7, wherein
the reflective coating is a metal film coating and/or a multi-layer film coating.

9. The image display apparatus according to claim 1, wherein
the first optical element and the second optical element have same pitch and same direction.

10. The image display apparatus according to claim 1, wherein
the first optical element and the second optical element are surface relief diffraction gratings.

11. The image display apparatus according to claim 1, wherein
the first optical element and the second optical element are holographic optical elements.

12. The image display apparatus according to claim 1, wherein
both the first optical element and the second optical element are reflection-type diffraction gratings or transmission-type diffraction gratings.

13. The image display apparatus according to claim 1, wherein
the first optical element and the second optical element are either a reflection-type diffraction grating or a transmission-type diffraction grating.

14. The image display apparatus according to claim 1, wherein
the first optical element and the second optical element are either a prism or a multi-mirror.

15. The image display apparatus according to claim 1, wherein
two or more pairs of the reflective curved surfaces are formed on the side surfaces of the light guide plate.

16. The image display apparatus according to claim 1, wherein
the image forming unit has an image generation unit that emits the image light and an optical system that converts the image light emitted from the image generation unit into collimated light for an angle of view.

17. The image display apparatus according to claim 1, wherein
the image forming unit has a color filter.

18. The image display apparatus according to claim 1, wherein
the light guide plate includes a plurality of stacked light guide plates.

19. The image display apparatus according to claim 1, wherein
the image display apparatus is an eyewear attached to vicinity of a user's eye.

20. An image display method, comprising:
a step of emitting image light;
a step of causing the emitted image light to enter a light guide plate;
a step of causing the image light entering the light guide plate to be refracted by a first optical element and travel inside the light guide plate;
a step of causing the image light entering the first optical element to be reflected in a direction of a second optical element, the image light being reflected on at least one pair of reflective curved surfaces formed on side surfaces of the light guide plate; and
a step of causing the image light traveling inside the light guide plate to be refracted by the second optical element and emitted outward from the light guide plate.
